(19) United States
(12) Patent Application Publication
(10) Pub. No.: US 2001/0007085 A1
(43) Pub. Date: Jul. 5, 2001

(54) Method and system for supervising reference wafers on semiconductor device production line and recording medium

(75) Inventor: Yutaka Sugikawa, Tokyo (JP)

Correspondence Address: HELFGOTT & KARAS P.C., Empire State Building, 60th Floor, New York, NY, 10118-0110, US

(73) Assignee: NEC CORPORATION

(21) Appl. No.: 09/746,343

(22) Filed: Dec. 22, 2000

(30) Foreign Application Priority Data
Dec. 24, 1999 (JP) 11-367493

(51) Int. Cl. G06F 19/00

(52) U.S. Cl. 700/121; 700/115; 700/213; 700/214; 700/219; 700/225

(57) ABSTRACT

Provision of a shelf management system and method for semiconductor devices enabling efficient use of a reference wafer storage shelf and also enabling stop of process progress of product lot in case of unusual data representing reference wafer measurement results. A production control system responsible for supervision of a production line has a function of changing the reference wafer item name. The production control system accords a preset common representative name to plural reference wafers. Upon warehousing plural reference wafers to a storage shelf, the reference wafers are collectively stored in a storage shelf, without classification according to processing conditions in the wafer process device where the reference wafers are to be processed. The item name is changed to a name corresponding to the processing conditions at the time of processing the reference wafers in the wafer process device.

### FIELD OF THE INVENTION

This invention relates to a production control system for semiconductor devices and, more particularly, to a system and a method for supervising reference wafers in a semiconductor device production process, and to a program product.

### BACKGROUND OF THE INVENTION

A reference wafer used for testing, evaluation, maintenance and inspection, is processed under a preset condition along with a product wafer in an oxidation device, a diffusion device, a CVD device or in an epitaxial growth device, referred to below as a wafer process device, in e.g., an oxide film forming step, a thermal diffusion process, a CVD process or in an epitaxial growth process. After the end of the processing, the film thickness of the reference wafer, for example, is measured by a film thickness measurement device to check whether or not the reference wafer will behave satisfactorily in the wafer process device.

Up to now, in a production line for semiconductor devices, a preset number of item names are provided on the side production control system at the outset for reference wafers used in a given process for testing and maintenance in association with different processing conditions in the process of the wafer process device so that the reference wafers are warehoused on a storage shelf as the wafers are classified on the condition basis. Specifically, the reference wafers are warehoused on the storage shelf in the locations associated with the processing conditions for the reference wafers. Meanwhile, an automatic warehousing/delivery mechanism for a carrier is usually provided on a wafer storage shelf provided in a clean room such that warehousing operations of the wafer-accommodating carrier on the shelf and delivery of the carrier therefrom are carried out automatically.

In the process in need of reference wafer processing, the storage shelf storing the reference wafer is responsive to an operational command transmitted from the production control system side supervising the process or to an operational command by an operator to deliver a set of a carrier accommodating product wafers associated with the processing condition in the wafer process device on the lot basis and a carrier accommodating a preset number of, e.g., one lot of reference wafers associated with the product wafer condition. This set is also refer red to below as a batch set. The batch set is transported to a wafer process device of destination, by a transporting car, namely an unmanned transporting car, under control by an automatic transporting system.

In the conventional production line, the lot ID of the product lot, that is a lot identification information, also termed a lot number, of the product lot, and the lot ID of the reference wafer, are noted down on e.g., a memo, by an operator, for supervising the correspondence between the product lot and the reference lot.

The product wafers and the reference wafer(s), transported to the wafer process device, are automatically loaded in a process chamber of the wafer process device for film-forming processing under a preset condition. FIG. 17 schematically shows a typical batch-type longitudinal oxidation device. In a longitudinal oxidation device 30A, the product wafer and the reference wafer are automatically loaded into a chamber 31 by a loader 32. An electrical oven 34 then is driven and a gas starts to be supplied to form an oxide film. At this time, one reference wafer is loaded per a preset number of, for example, 25 product wafers, these wafers being processing simultaneously.

After the end of the processing in the wafer process device, the product lot and the reference wafer(s) are recovered from the wafer process device. The product lot is transported to the next step, such as rinsing step, as being already processed, whilst the reference wafer is measured by a measurement device, such as a film thickness measurement device.

The measured results of the reference wafer(s) are compared to preset standard values, such as upper and lower values. If the measured data indicate a negative result (NG), the progress of the processing of the product lot, Processed simultaneously with the reference wafer(s) in the wafer process device 30, needs to be halted.

### SUMMARY OF THE DISCLOSURE

However, there is much to be desired in the art. Namely, the following problems have been encountered in the investigations toward the present invention.

In the above-described conventional system, the management of the reference wafer lot and the product lot are supervised by an operator by noting down on a memo etc., at the time of delivery form the storage shelf, such operation being troublesome and liable to occurrence of mistaken noting or failure in noting.

If the measured data for the reference wafer is not good (NG), the operation of identifying the product wafers belonging to the product lot processed simultaneously with the reference wafer from the memo is time-consuming, such that there is a risk of the product lot processed in the same set as the reference wafer be introduced into the next process. Moreover, if the product lot processed in the same set as the reference wafer could be identified e.g., from the memo, it is not so easy to halt the progress of the process for the product lot. The reason is that, since the reference wafer is discarded after processing in the wafer process device and measurement in the measurement device, in distinction from the product lot, the conventional production control system is not provided with the function of supervising the correspondence between the reference wafer and the product lot, and that it is extremely difficult to check whether or not the product lot being transported by e.g., an unmanned transporting car to the next step after processing in the wafer process device is the product lot processed in the same set as the reference wafer.

If the measured result in the reference wafer measurement device is to be checked manually, and if the measured result of the reference wafer is NG, it is difficult to halt the progress of the product lot process immediately, by the same reason as discussed above.

In the conventional system, described above, the reference wafer carriers, afforded at the outset with item names depending on the conditions in the wafer process device, are stored in a classified state in the storage shelf. That is, the reference wafers need to be stored in the storage shelf from carrier to carrier in association with the conditions of the processing performed in the wafer process device.

However, in this sort of the reference wafer storage method, the number of reciprocally different conditions is increased with the number of the processing conditions in the respective wafer process devices, such as temperature, processing time or species of the gas supplied, either alone or in combination, so that, if the carriers holding reference wafers classified depending on conditions are placed on the storage shelf, the space necessary for saving the reference wafers is increased, with the result that the shelf storage capacity is in shortage. If the shelf capacity is to be increased, the effective clean room space is decreased correspondingly.

In order to combat the problem that, in supervising the reference wafers, reference wafer insertion and extraction is carried out in the clean room by e.g., a written command to the operator in the clean room, while the number of the reference wafers is not checked in the system, which reference wafer has become defective in which operation cannot be left as data, there is disclosed in the JP Patent Kokai JP-A-5-304064 a management device having means for detecting the introduction or extraction of the semiconductor wafer from a product lot, a lot master file for memorizing the processing state of the semiconductor wafer, an operating condition file having the processing state of the semiconductor wafer for each operation and the possible presence of an operation as flags, and from changes in the flags with the progress of the process in the operating condition file. The management device automatically instructs the introduction and extraction of the reference wafers into or from the semiconductor wafer process which takes place on the lot basis.

Moreover, as a production control system for eliminating the problem of failure in reference wafer introduction or extraction and for automating the reference wafer management, there is disclosed in e.g., JP Patent Kokai JP-A-9-186215 such a system in which control is managed so that the lot which has reached a process in need of a reference wafer is switched to the reference wafer process sequence data, a command for operation is issued in accordance with the reference wafer process sequence data and the number of the wafers is increased or decreased in association with the processing of introducing and extracting the reference wafers.

In addition, there is disclosed in e.g., the JP Patent Kokai JP-A-7-74675 the configuration of a reference wafer number management device in which operation command means is caused to issue a command as to the processing on each reference wafer in the product lot and in which there is provided updating inputting means for changing the contents of the processing and the operating conditions of the reference wafers.

In the above-described systems, described in the above-mentioned publications, it is envisaged to realize automatic reference wafer introduction and extraction. However, the problem presented during storage in the storage shelf of the reference wafers is not taken into account, whilst management of the data and the lots of the reference wafer and the product wafers or the manner of dealing with the negative state (NG) of the measured data of the reference wafers is also not taken into account.

It is therefore an object of the present invention to provide a shelf management system and method for semiconductor devices which enables efficient use of the shelves storing the reference wafers.

It is another object of the present invention to provide a production control system and method for automating the correspondence between the reference wafer lot and the product lot and its management, and a program product.

It is still another object of the present invention to provide a production control system and method for appending measured data of the reference wafer to the product wafer data to realize efficient defect analyses of products, and a program product therefor.

It is yet another object of the present invention to provide a production control system and method for enabling the processing of a product lot to be halted immediately if the measured results of a reference wafer is negative, and a program product therefor.

According to a first aspect of the present invention, there is provided a method for supervising a reference wafer introduced as specimen into a production line for semiconductor devices, comprising:

(a) providing a system for supervising the production line with a function of changing the item name of the reference wafer;

(b) according, in the system, a preset common representative name to plural reference wafers introduced for maintenance or evaluation of a wafer process device; and

(c) accommodating, upon warehousing the plural reference wafers to a storage shelf, the reference wafers in the storage shelf collectively without classification according to processing conditions in the wafer process device in which the reference wafers are to be processed.

According to a second aspect of the present invention, there is provided a method for supervising reference wafers introduced as specimens into a production line for semiconductor devices, comprising the steps of:

(a) according a preset common representative name as an item name to plural reference wafers introduced into a wafer process device, memorizing and supervising the representative name;

(b) holding the representative name of the reference wafer as from the time of warehousing the reference wafer on the storage shelf until delivery thereof from the storage shelf and confirmation of actual processing to be performed in the wafer process device; and

(c) changing the item name of the reference wafer from the representative name to an item name adapted for conditions of the actual processing if it is confirmed that the processing is to be made in the wafer process device.

According to the present invention, the reference wafer stored in the storage shelf is delivered as a set with product wafers and, at a time point when the set is processed on the wafer process device, the item name of the reference wafer is changed to an item name having the same condition as the product wafers.

According to a third aspect of the present invention, there is provided a storage shelf for storing a reference wafer or both a reference wafer and a product wafer as a lot, wherein, upon introducing plural reference wafers into a line, plural reference wafers, afforded with a preset representative name in the production control system, are accommodated collectively as a lot without classification in accordance with processing conditions in the wafer process device where the reference wafers are to be processed.

According to a fourth aspect of the present invention, there is provided a production control system for supervising wafers introduced into a line, comprising means for affording the reference wafers with a preset representative name, upon introducing the reference wafers, and means for changing, at a time point of processing the reference wafers in a wafer process device, an item name of the reference wafers from the representative name to an item name conforming to the processing conditions.

According to a 5th aspect of the present invention, there is provided a reference wafer supervising system comprising a shelf management system having a storage shelf for storing wafers to be introduced into a production line and adapted for automatic warehousing and delivery of the wafers, a wafer process device, a control system controlling automatic transporting of the wafers, a production control system for supervising a production line of semiconductor devices, and a measurement device for measuring reference wafers as specimens. The production control system affords a preset common representative name to plural reference wafers and introduces the wafers into a line. The storage shelf is designed to collectively accommodate the reference wafers without classification in accordance with conditions under which the reference wafers are to be processed. The system also includes means for changing an item number of the reference wafers delivered from the storage shelf for processing in the wafer process device, at a time point when the processing is finished, to an item name conforming to a condition under which the reference wafers are processed in the wafer process device.

According to a 6th aspect of the present invention, there is provided means in the production control system which, if the processing is finished in the wafer process device, notifies a lot ID of the product wafers and a lot ID of the reference wafers processed simultaneously in the wafer process device to the production control system, and which registers and supervises the relation of correspondence between the lot ID of the product wafers and the lot ID of the reference wafers.

According to the present invention, there is provided means which, after the end of processing in the wafer process device, measures the reference wafer(s) in the measurement device, and appends (or adds) the measured result in the measurement device to the processed data in the wafer process device in the database provided in the production control system. According to the present invention, there is also provided control means for automatically verifying whether the measured results in the reference wafer measurement device are positive or negative and for managing control for stopping transfer to and processing in the next step of the product lot processed by the wafer process device in the same set as the reference wafers if the verified results are negative.

According to the present invention, there is also provided control means for automatically verifying whether the measured results in the reference wafer measurement device are positive or negative and for issuing an alarm if the verified results are negative. The control means specifies a product lot processed by the wafer process device in the same set as the reference wafer(s) for advising an operator of necessary measures.

### BRIEF DESCRIPTION OF THE DRAWINGS

FIG. 1 shows a system configuration of an embodiment of the present invention.

FIG. 2 shows a production control system of an embodiment of the present invention.

FIGS. 3a and 3b show a configuration of a reference wafer item name management unit and a lot data management unit, respectively, of a production control system according to the present invention.

FIG. 4 shows a configuration of a standard value management unit of the production control system according to an embodiment of the present invention.

FIG. 5 illustrates item name change of a reference wafer in an embodiment of the present invention.

FIG. 6, similarly to FIG. 5, illustrates item name change of a reference wafer in an embodiment of the present invention.

FIG. 7, similarly to FIGS. 5 and 6, illustrates item name change of a reference wafer in an embodiment of the present invention.

FIG. 8 illustrates supply and recovery of the reference wafer and the product lots in an embodiment of the present invention.

FIG. 9 illustrates correspondence between the reference wafer and the product lot and extension of measurement data in an embodiment of the present invention.

FIG. 10 is a flowchart showing a processing sequence in an embodiment of the present invention.

FIG. 11 illustrates item name change of the reference wafers in a second embodiment of the present invention.

FIG. 12 illustrates supply of a reference wafer lot in a second embodiment of the present invention.

FIG. 13 illustrates the supply and the recovery of the product lot in the second embodiment of the present invention.

FIG. 14 is a flowchart showing the processing sequence in the second embodiment of the present invention.

FIG. 15, similarly to FIG. 14, is a flowchart showing the processing sequence in the second embodiment of the present invention.

FIG. 16 schematically shows a wafer process device used in the second embodiment of the present invention.

FIG. 17 schematically shows a configuration of a batch type wafer process device.

### PREFERRED EMBODIMENTS OF THE INVENTION

In the following certain preferred embodiments of the present invention are explained. In a preferred embodiment of the present invention, there is provided means for affording reference wafers with a preset common representative name at the time of charging (introducing) thereof and for changing the item name of the reference wafers from the representative name into an item name conforming to the processing condition.

In a preferred embodiment of the present invention, the charged (introduced) plural reference wafers are afforded with a common representative name and holds it during warehousing to and delivery from the shelf and during transport.

So, it is unnecessary to sort the plural reference wafers stored on the shelf according to processing conditions in the wafer process device, such that the reference wafers are stored collectively on the storage shelf. In this preferred embodiment of the present invention, the operation of searching for a shelf matched to the processing condition in the wafer process device when the reference wafers are to be sent from the storage shelf to the wafer process device in need of the reference wafers is not needed, but it is sufficient to sequentially take out the reference wafers, stored collectively, thus simplifying the control of the entrance/exit to or from the shelf.

The schematics of the preferred embodiment of the present invention are hereinafter explained. The production control system responsible for process management monitors the state of the wafer process device and notifies the request for the next-processed product lot in the wafer process device to a shelf management system responsible for storage shelf management.

The shelf management system selects the product wafers processed under the same condition in the wafer process device from the storage shelf holding the reference wafer(s) and the product wafers and accommodate the wafers on the lot basis in separate supply carriers, while accommodating one lot of the reference wafers in the (same) supply carrier carrying one lot of product wafers. The combination of these lots (i.e., a lot of product wafers and a lot of reference wafers) are termed a set or a batch set.

If, in the shelf management system, the product lot and the reference wafer lot are to be delivered from the storage shelf, the delivery number is notified to the production control system. On receipt of this delivery signal, the production control system, supervising the wafer progress on the line, recognizes that the product lot and the reference wafer lot have been delivered. In the database provided on the production control system, this delivery signal operates as a command signal for changing the item name of the delivered reference wafer to an item name corresponding to the condition which is the same as that of the product wafers.

The carrier for the product lot and the reference wafer lot, delivered from the storage shelf, are transported from the shelf to the wafer process device on a transport car.

When the product wafers and the reference wafer(s) are loaded and processed in a chamber in the wafer process device, an item name change command is forwarded from the wafer process device to the production control system.

The production control system in the database is responsive thereto to change the item name of the delivered reference wafer to an item name conforming to the same condition as that of the product wafers.

After the end of processing in the wafer process device, the product lot and the reference wafer lot both processed are transported and recovered. At a time point when the processing in the wafer process device is finished, the correspondence between the product lot and the reference wafer lot is notified to the production control system for registration and management therein.

The product lot recovered is transported to the next process.

The reference wafers recovered are routed to a measurement device for measurement. The reference wafers, measurement for which in the measurement device is finished, is warehoused in the storage shelf.

The measured data obtained in the measurement device for the reference wafers are appended in the database of the production control system to the portion of data of the product wafers processed in the wafer process device in the same set as the reference wafers that is relevant to the process of the wafer process device. This appending is termed as “expanding” in the present invention.

The production control system checks whether the measured results in the reference wafer measurement device are positive or negative and, if the results are negative, the production control system manages control to halt the introducing the product lot processed in the same set as the reference wafers to the next step and the processing in such next step to halt the progress of the processing for the product lot. If the results are negative, it is also possible to issue an alarm and to specify the product lot processed in the same set as the reference wafers to notify necessary measures to an operator.

### Embodiment of the Invention

For further explanation of the above-described embodiments of the present invention, certain preferred embodiments of the present invention are hereinafter explained in detail.

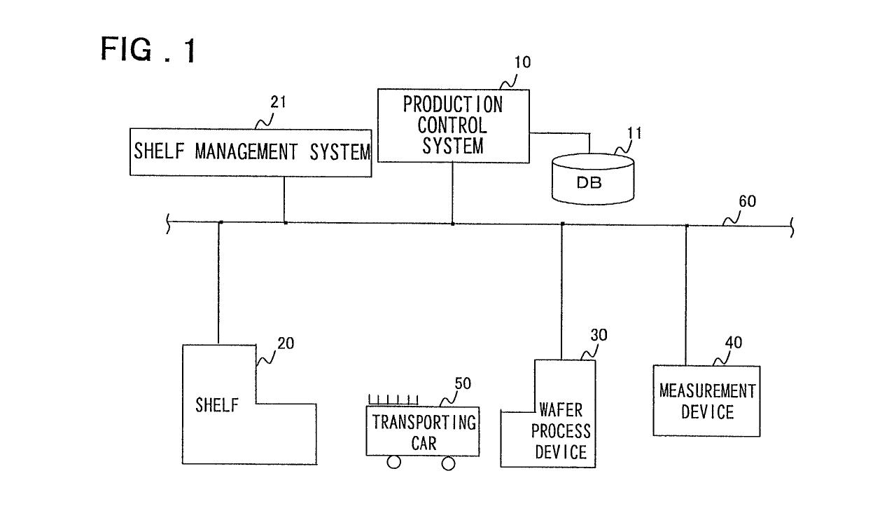

FIG. 1 shows a system configuration of an embodiment of the present invention. Referring to FIG. 1, the preferred embodiment includes a production control system 10 which is comprised of a data processing device including a database 11 and which performs production, the process and data management on a production line. The embodiment also includes a storage shelf 20 for storage of wafers supplied to a production line, a shelf management system 21 for controlling automatic wafer warehousing to and wafer delivery from the storage shelf 20 under control by the production control system 10, a wafer process device 30, a measurement device 40 for measuring a reference wafer as a specimen or a non-product wafer NPW and a transfer car 50 in a clean room. These systems or devices are interconnected over a network 60, such as LAN (Local Area Network). A control system, not shown, for automatically transporting the transfer car 50 may be any suitable known device. Only one wafer process device 30 is shown in FIG. 1 for facilitating the explanation. However, a plurality of similar or different devices, such as an oxide film devices, a diffusion device or a CVD device, may be provided as necessary. The wafer process device is preferably a batch type device as explained with reference to FIG. 17.

The production control system 10, performing process management or wafer-based data management, accords a predetermined common representative name to the reference wafers used for maintenance and evaluation of the wafer process device 30 as an item name, for storage and management on the database 11, without setting a condition-specifying item name.

That is, at the time point of warehousing in the storage shelf 20, a representative name (general-purpose item name), having a preset temp late name, as a condition, without according a condition corresponding to the processing condition of a product wafer processed by the wafer process device 30.

Plural reference wafers, entered to the storage shelf 20, are accommodated collectively, without classification in accordance with the processing conditions in the wafer process device 30.

If, in an embodiment of the present invention, a reference wafer is to be delivered from the storage shelf 20, the reference wafers collected at one location for processing by the wafer process device 30 are sequentially taken out and inserted into a carrier, such that there is no necessity of searching the location of the reference wafers collected separately according to conditions etc., to simplify the reference wafer take-out operation. When delivered from the shelf, the reference wafers are stored in a carrier in terms of a lot as a unit for storage, with each lot comprising e.g., five wafers.

Also, product wafers processed under the processing conditions used in the wafer process device 30 are taken out from the storage shelf 20. These wafers need not be the same products, it being only necessary if the wafers are processed under the same condition. The product wafers are inserted into a carrier in terms of a lot as a unit for storage, with each lot usually comprising 25 wafers. A batch set of these carriers are loaded on a transfer car 50, along with the reference wafer lot.

At a time point when the reference wafers taken out from the storage shelf 20 are delivered from the storage shelf 20, the shelf management system 21 transmits to the production control system 10 a signal commanding change of the item name of the delivered reference wafer to an item name conforming to the condition afforded to the reference wafer.

On receipt of this command signal, the production control system 10 acquires the condition information in the wafer process device 30 of the product wafers processed simultaneously with the reference wafers, without immediately proceeding to change the item name of the reference wafer. Meanwhile, respective steps for the product wafers are stored in the database 11 of the production control system 10 responsible for process management, in the order of the process steps, in association with the information on the processing conditions in the wafer process device.

When the reference wafers lot and the product wafers lot are transferred from the storage shelf 20 to the target wafer process device 30 and loaded in a chamber of the wafer process device 30, and the processing for the reference wafers and the product wafers is started, the wafer process device 30 sends a processing start signal to the production control system 10.

On receipt of the command for changing the item name from the shelf management system 20 and of the processing start signal from the wafer process device 30, the production control system 10 changes the item name (common representative name) of the reference wafers stored in the database 11 in to a specific item name corresponding to any of the processing conditions.

The reason the item name change is control led in two stages in an embodiment of the present invention is as follows: In the process from the delivery of a reference wafer from the storage shelf 20 until a time directly prior to processing starting through the process of transport by the transfer car 50 and loading into the chamber of the wafer process device 30, it may be an occurrence that the reference wafers are damaged, cease to be processed or the transfer car 50 falls into a disorder to disable the starting of the processing. If the item name reflecting the processing condition for a non-processed reference wafers is set at the outset, the reference wafers cannot cope efficiently with (i.e., follow up or reflect) changes in a processing condition different from the first-stated processing condition thus complicating the wafer management. So, in a preferred embodiment of the present invention, the representative name of the reference wafer is kept, since the warehousing of the reference wafer to the storage shelf 20, reference wafer delivery and reference wafer transfer until establishment of the processing in the storage shelf 20, with the representative name being then changed to an item name reflecting the reference wafer item name to assure reliability and matching of management of the reference wafers. If the timing of changing the item name (representative name) of the reference wafer stored in the database 11 to the item name associated with the processing condition is slightly offset temporally from the time point of start of processing in the wafer process device 30, it may be changed at a proper time until end of the processing in the wafer process device 30.

In an embodiment of the present invention, the relation of correspondence between the lot ID or lot number of the product wafers and the lot ID of the product wafers, processed as being of the same set, is notified, after the end of the processing in the wafer process device 30, to the production control system 10, which then supervises this relation of correspondence in the database 11.

After the end of processing in the wafer process device 30, the product lot and the reference wafers are recovered by the transfer car 50 and are routed to the processing of the next process step, such as rinsing step, if the wafer process device 30 is e.g., an oxidizing device.

The reference wafer recovered is transferred to a measurement device 40 where necessary measurement and inspection are carried out. The measurement device 40 transmits the measured results to the production control system 10.

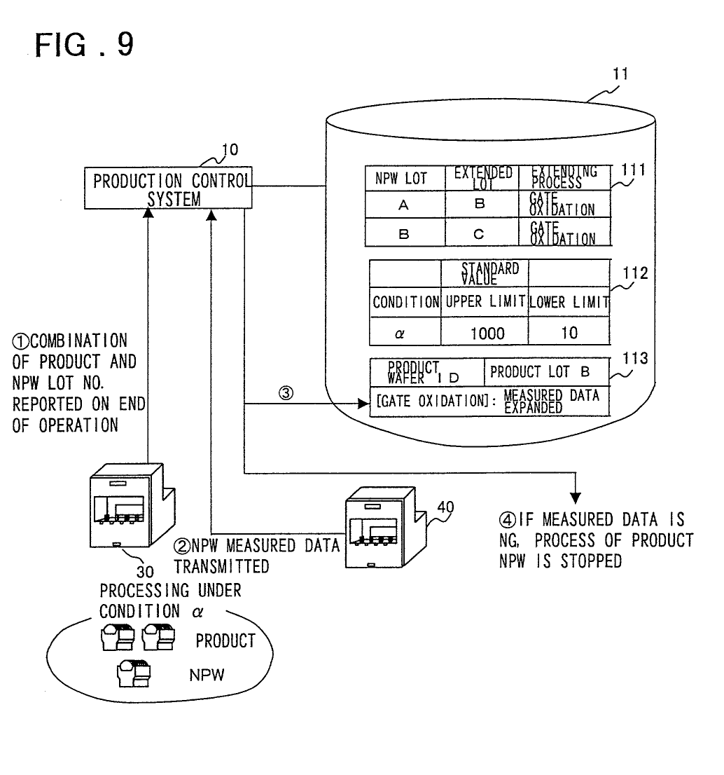

The production control system 10 retrieves the lot ID of the product lot processed in the wafer process device 30 as being the same batch group as the lot of the reference wafers, and the product wafers processed in the lot ID, from the database 11, to store the measured results in a data column corresponding to the processing step of the wafer process device 30 in a record of the product wafers data in the database 11 (see \mathring{3}in FIG. 9).

The production control system 10 compares the measured results obtained by the measurement device 40 for the reference wafers to standard values for the processing conditions for the reference wafers in the database 11 (112 of FIG. 9) to verify the state of the wafer process device 30. If the verified result is bad, the production control system 10 manages control to terminate the transfer to the next step of the product lot of the same set (same batch set) as the reference wafers processed by the wafer process device 30 and the processing at the next step.

The production control system 10 memorizes and supervises the item name and the lot ID for the reference wafers in the database 11. If the reference wafers are verified by the measurement device 40 be unacceptable, the production control system 10 retrieves a lot ID of the product lot processed in the wafer process device 30, by taking the number of the lot of the reference wafers and the lot of the reference wafers as one set, and outputs to an output device indicating in which step and state on the production line is the product lot processed by the wafer process device 30 as the same set as the reference wafer lot, from the current process information of the product wafers of the lot ID. If the product lot is being currently processed by a certain wafer process device, the production control system 10 is able to take necessary measures, such as commanding the processing to be terminated, or issuing alarms to the wafer process device.

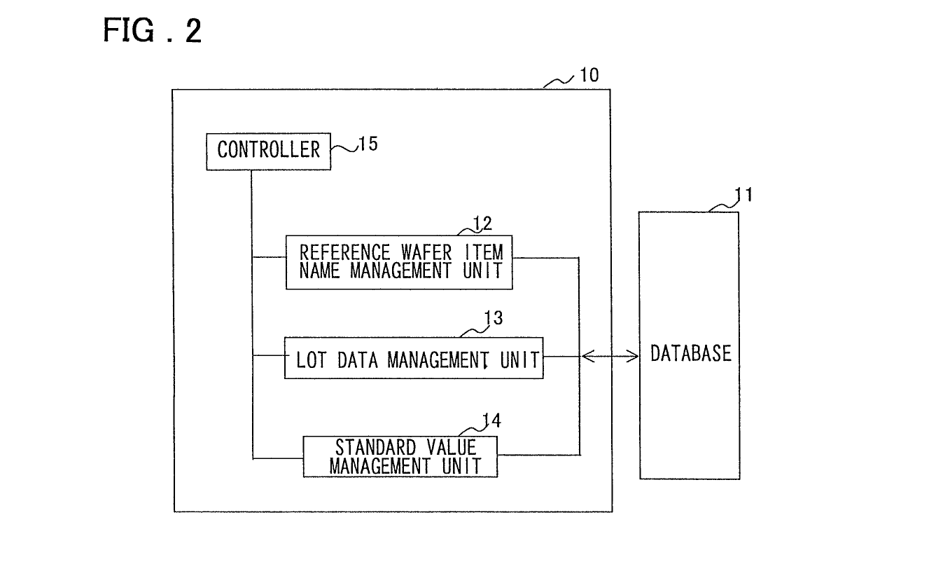

FIG. 2 shows a typical structure of the production control system 10 according to an embodiment of the present invention. Referring to FIG. 2, the production control system 10 in the preferred embodiment of the present invention is explained. The production control system 10 includes a reference wafer item name management unit 12, supervising pre-change and post-change item names of the reference wafers, a lot data management unit 13, a standard value management unit 14, supervising condition-based standard values, and a controller 15 for performing overall control. The lot data management unit 13 supervises the correspondence between data and the reference wafer lot and product wafers processed by the wafer process device 30.

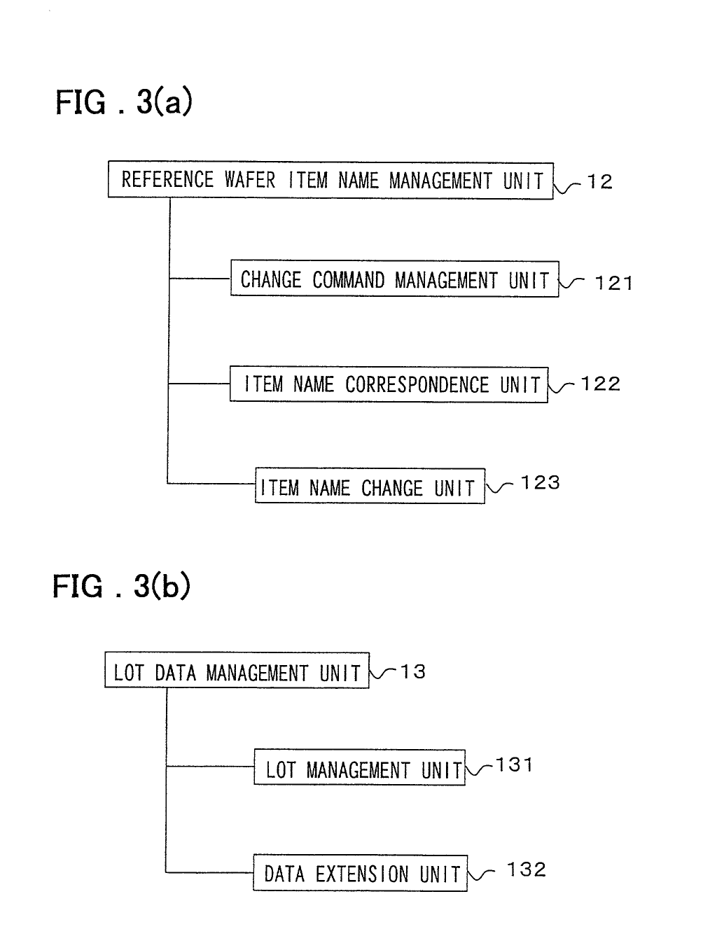

FIG. 3a shows a typical structure of the reference wafer item name management unit 12 of the production control system 10. Referring to FIG. 3a, the reference wafer item name management unit 12 includes a change command management unit 121 for supervising reference wafer item name change commands from the shelf management system 21 and the wafer process device 30, an item name accommodating unit 122 for associating the pre-change item name with the post-change item name of the reference wafer in the database 111 and an item name change unit 123 for changing the item name of the reference wafer in the database 11.

FIG. 3b shows a typical structure of the lot data management unit 13 of the production control system 10. Referring to FIG. 3b, the lot data management unit 13 includes a lot management unit 131 for supervising the correspondence between product lot and reference wafer lot ID, processed as one batch, responsive to an end signal from the wafer process device 30, on termination of processing in the wafer process device 30, and a data expansion unit 132 for setting the measured data in the measurement device 40 of the processed reference wafer in the data of the product wafers.

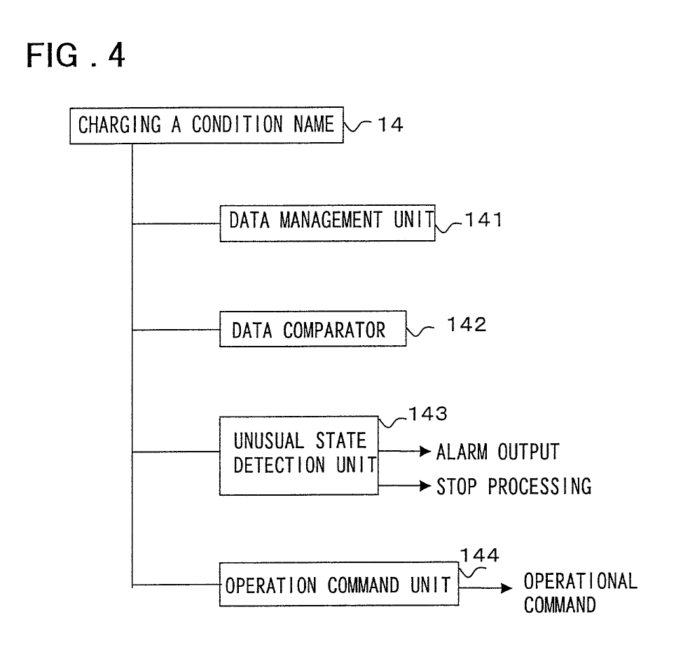

FIG. 4 shows a typical structure of the standard value management unit 14 of the production control system 10. Referring to FIG. 4, the standard value management unit 14 includes a data management unit 141 for supervising the setting in the database 11 of the condition-based standard values (upper and lower limit values) in the wafer process device 30, a data comparator unit 142 for comparing measured data in the measurement device 40 for the processed reference wafers to standard values and an unusual state detection unit 143 for managing control such as to terminate the processing of the product lot processed simultaneously as the reference wafer, the measured value of which obtained on comparison in the data comparator unit 142 exceed or fall short of the standard value, and for issuing an alarm. The standard value management unit 14 also includes an operation command unit 144 for outputting to the display device a processing required for a reference wafer or a product wafers, in case measured data of the reference wafer exceeds or falls short of the standard value, by way of commanding a corresponding operation.

The functions of the reference wafer item name management unit 12, lot data management unit 13, standard value management unit 14 and the controller 15 for the overall operations are realized by a program product, executed on a computer making up the production control system. In this case, the program may be read out from a medium, e.g., a recording medium having recorded thereon the program, such as FD or MT (magnetic tape), a CD-ROM, a DVD (digital versatile disc) or a semiconductor memory, or from the wired or wireless communication medium, through a readout device and a preset interface, both not shown, for execution on a main computer memory, by way of carrying out the present invention.

Specifically, the program executed on a data processing device (computer), constituting the production control system 10, includes the processing (a) of affording, at the time of charging plural reference wafers into a line, a predetermined common representative name to the reference wafers, and of changing, at a time point of processing the reference wafers and the product wafers on the wafer process device 30, the item name of the reference wafer from the representative name to an item name conforming to the processing condition in the wafer process device 30, responsive to the end signal from the wafer process device 30, (b) supervising the correspondence between the lot ID of the reference wafer and the product lot processed as being of the dame batch set, responsive to the end signal from the wafer process device 30 at the end of the processing in the wafer process device 30, (c) setting measured data obtained by the measurement device 40 of the processed reference wafer in the wafer process device 30 to data of the product wafer, (d) comparing measured data obtained by the measurement device 40 for the reference wafer processed in the wafer process device 30 to standard values, and (e) managing control to terminate the processing of the product lot processed simultaneously as the reference wafer if the result of comparison is negative.

The operation of an embodiment of the present invention is hereinafter explained in detail.

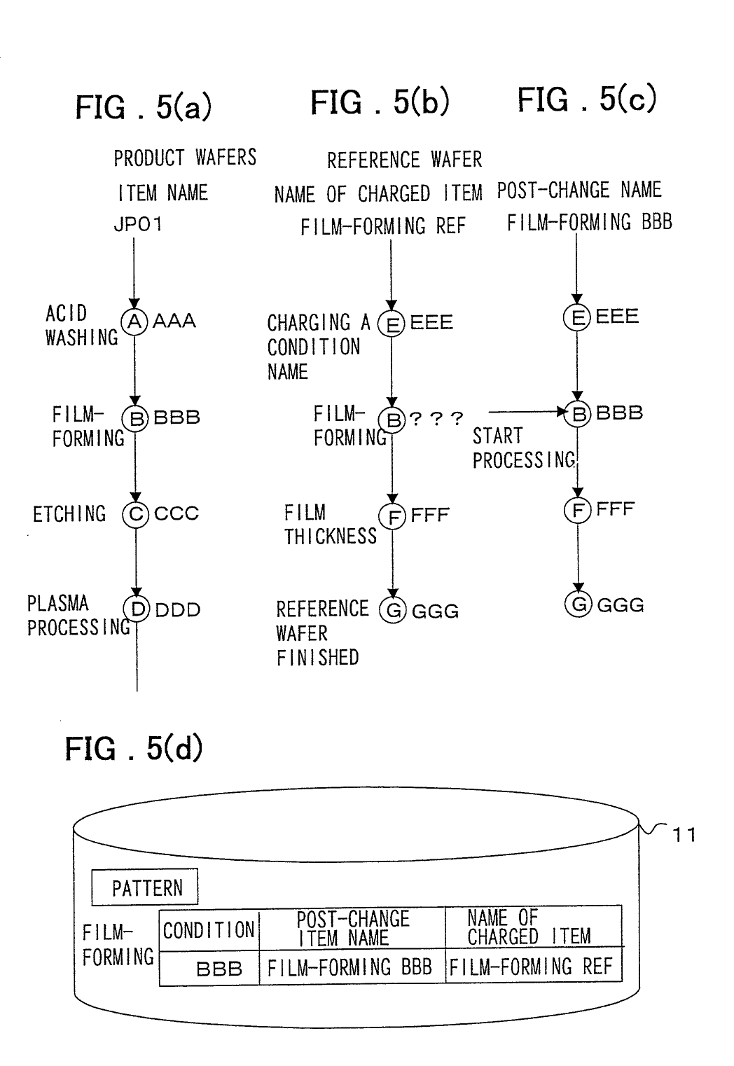

FIG. 5 illustrates item name change of the reference wafer in an embodiment of the present invention.

Referring to FIG. 5a, the processing sequence for a product wafer (item name: “JP01”) includes an acid washing step A (AAA), a film-forming step B (BBB), an etching step C(CCC), a plasma processing D (DDD) and so forth. Meanwhile, AAA, BBB, CCC and DDD in the steps A to D indicate the conditions in the respective steps. The condition information in each step of the processing sequence for the product wafer is memorized and supervised in the database 11 of the production control system 10 in association with the respective steps.

Referring to FIG. 5b, the item name of the reference wafer at the time of introducing to a line is set to, for example, “film forming REF” as a representative name. The processing sequence is made up of charging of the reference wafer (EEE), a film forming step B (???), film thickness measurement (FFF), . . . , and reference wafer warehousing G (GGG), where (EEE), (???), (FFF) and (GGG) represent the information indicating the conditions in the respective steps for the reference wafer(s).

In the reference wafer(s) supervised in the production control system 10, the condition information of the film forming step B is “???” of three digits of which one digit “48 ” is a wild card. Meanwhile, the condition “???” In the film forming step B is merely for the sake of illustration, with the number of the condition digits not being limited to three.

In the film forming step B, the reference wafer is processed simultaneously on the same wafer process device as that for the product wafers. In the film forming step B, the condition information (condition key) of the film forming step B of the product wafer, similarly to that of the product wafer of FIG. 5a, is set to “BBB” (see FIG. 5c), while the item name of the reference wafer is changed to “film forming BBB” to reflect the condition of the film forming step B. FIG. 5d shows an post-change item name and an as-introduced item name of the reference wafer stored and managed by the database 11.

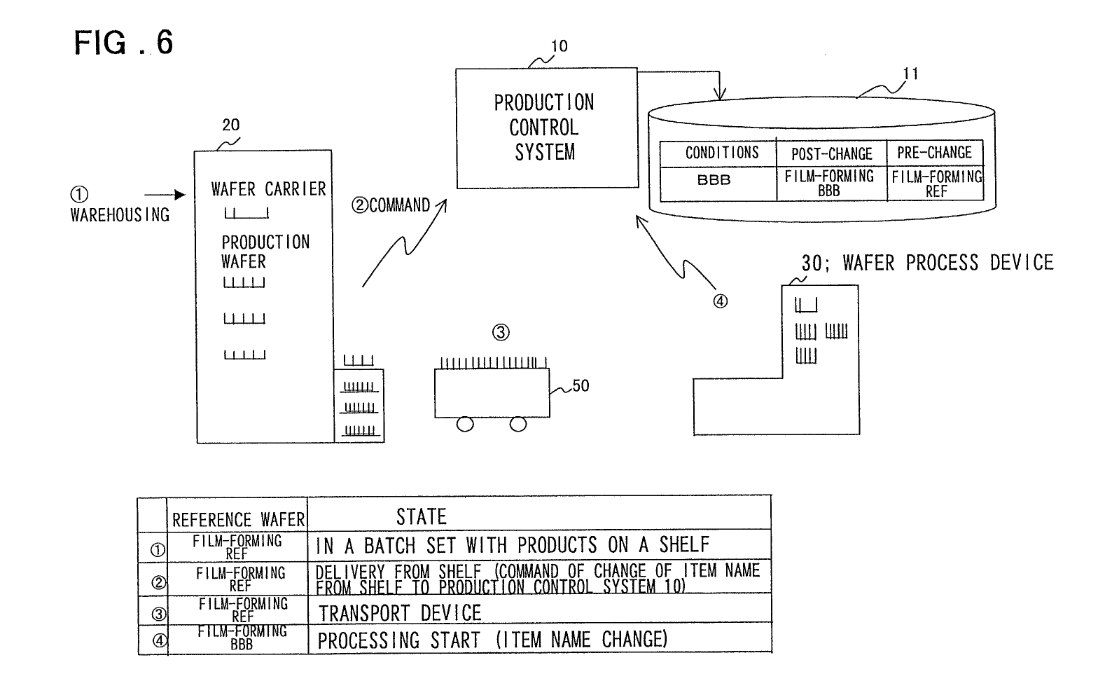

FIG. 6 schematically shows the processing sequence in changing item names in an embodiment of the present invention. Referring to FIGS. 1 and 6, the processing sequence in changing item names in the present embodiment of the present invention is explained.

At the time of warehousing in the storage shelf 20, the item name of the reference wafer has a representative name “film forming REF” (see FIG. 6 \mathring{1}). In taking out product wafers by the shelf management system 21 from the shelf for processing on the wafer process device 30 under commands from the production control system 10 for loading on a carrier, the item name of the reference wafer is kept as the representative name “film forming REF” even at a time point when one lot of plural reference wafers processed under the same conditions is taken out to form a batch set with the product lot.

At the time of delivery form the storage shelf, the shelf management system 21 transmits an item name change command to the product ion control system 10 (FIG. 6 at \mathring{2}). The item name of the reference wafers is kept as the representative name “film forming REF”.

At the time of delivery from the storage shelf, the shelf management system sends an item name change command to the production control system 10 (\mathring{3}of FIG. 6) the representative name of the reference wafers of (film-forming REF) is still kept.

In starting the processing in the wafer process device 30, the wafer process device 30 sends a processing start signal to the production control system 10 (FIG. 6 at \mathring{4}). The production control system 10 is responsive thereto to set the item name of the reference wafer of the database to “film-forming BBB” to reflect the condition information “BBB” of the product wafer in the wafers process device 30.

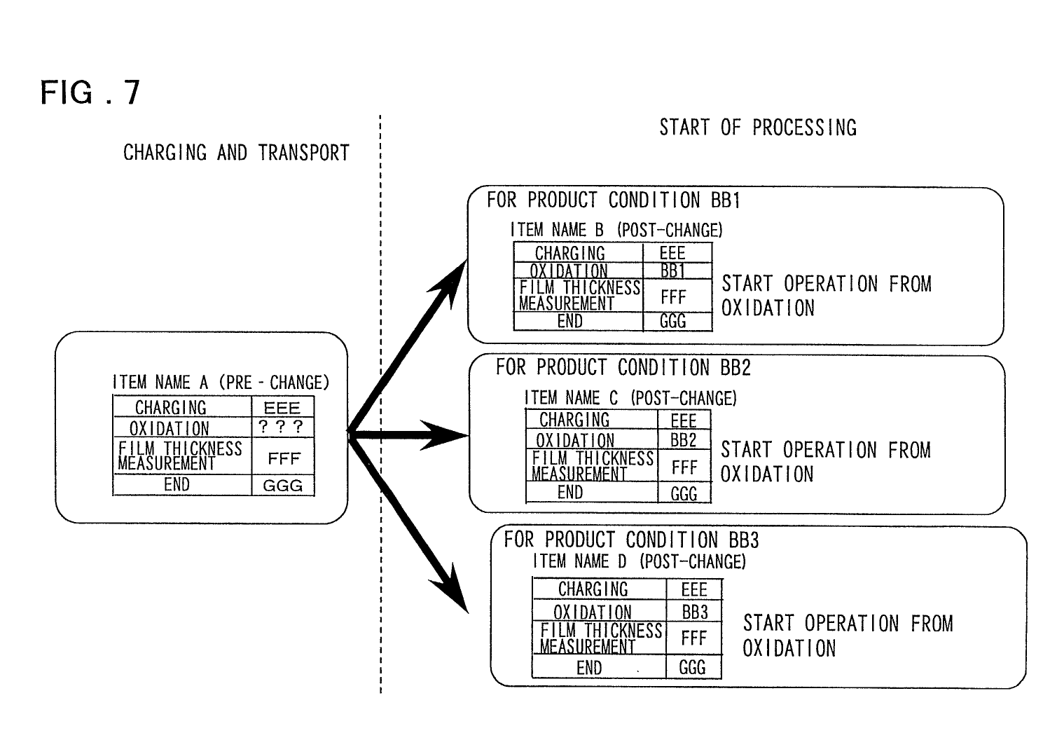

FIG. 7 illustrates item name change in an embodiment of the present invention. The wafer process device 30 is an oxidizing device. As for the reference wafer (item name: A) the charging process (condition “EEE”), oxidization process (condition “???”), oxide film thickness measuring step “condition: FFF” and the reference wafer completion step (condition: “GGG”) are stored and managed in the order of the process sequences in the database 11. In charging and transporting reference wafers, the condition for the oxidation condition is kept at “???”. In starting the processing at the oxidation process, the “???” for introducing and transport is changed to “BB1”, “BB2” and to “BB3”, respectively, thus three sorts of different item names (B, C and D) being derived after the start of the processing. The three different item names (B, C and D) are set to item names of, for example, film forming BB1, film forming BB2 and to film-forming BB3, for reflecting the conditions to “BB1”, “BB2” and to “BB3”, respectively.

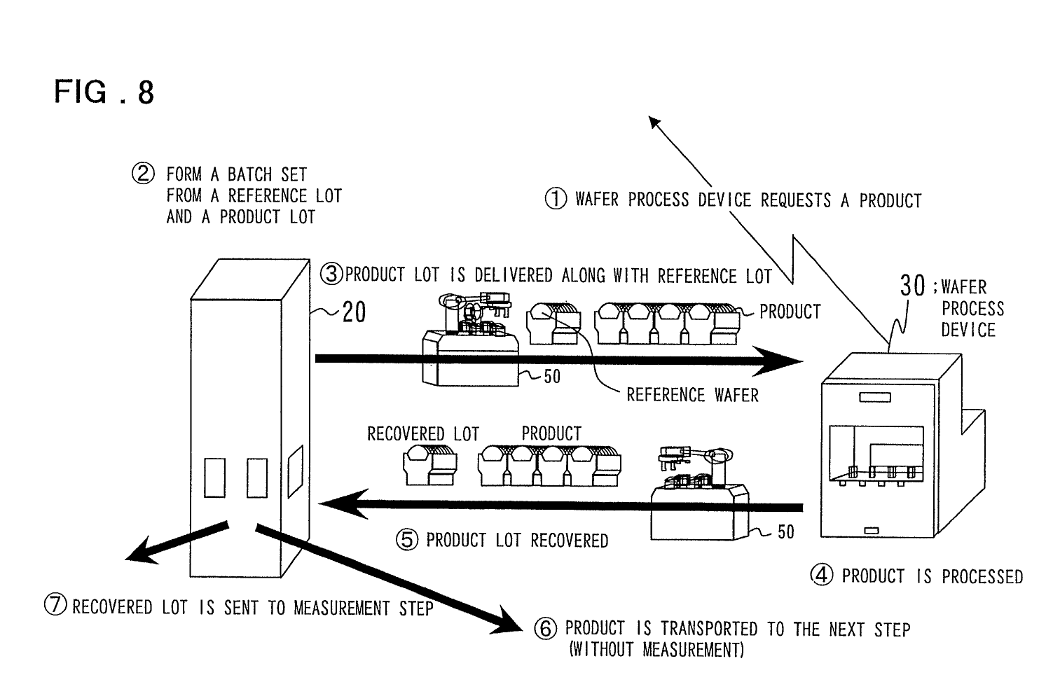

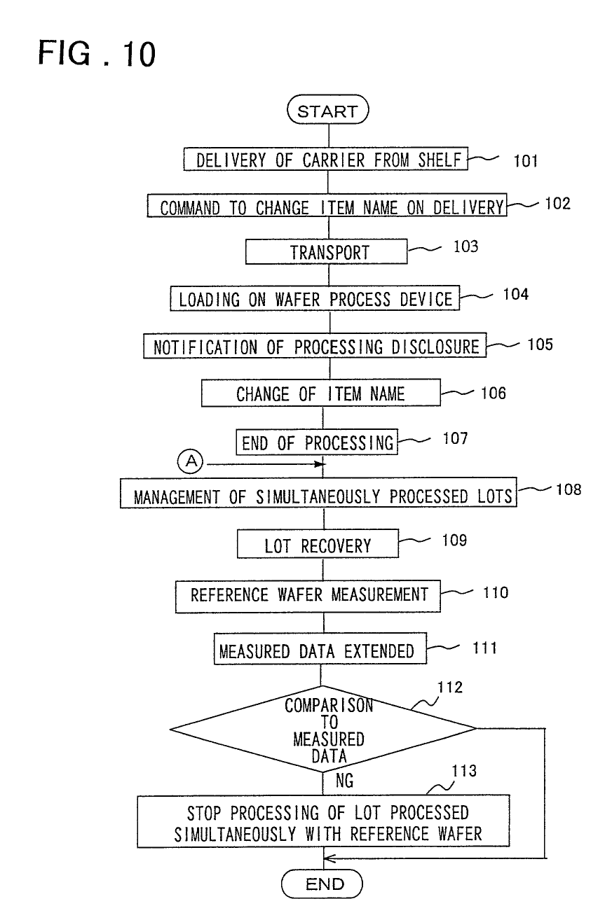

FIGS. 8 and 9 illustrate the processing of an embodiment of the present invention. FIG. 10 is a flow diagram for illustrating the processing of an embodiment of the present invention. Referring to FIGS. 8 to 10, the processing flow of an embodiment of the present invention is explained.

A request for a product lot from the wafer process device 30 is notified to the shelf management system 21 (\mathring{1}of FIG. 8).

In the storage shelf 20 in which to store reference wafers afforded with common representative name preset on the production control system 10 in charging and product wafers, the product wafers processed under the same conditions as those for the wafer process device 30 are selected and accommodated on the lot basis as lot (I) in a carrier, whilst one lot (II) of the reference wafers is accommodated in the same carrier. These lots (I and 11) are to be one batch set (\mathring{2}in FIG. 8, step 101 of FIG. 10).

In the shelf management system 21, a command is issued for changing the item names of the reference wafers delivered in the database 11 of the production control system 10 in delivering the product lot and the reference wafer lot from the storage shelf 20 to the name of the Process sequence having the same condition key as that of the product wafer (step 102 of FIG. 10).

One batch set is transported from the shelf 20 to the wafer process device 30 (\mathring{3}of FIG. 8, step 103 of FIG. 10).

The product wafers and the reference wafers are loaded in a chamber of the wafer process device 30 (step 104 of FIG. 10). In performing the processing, a notification is issued from the wafer process device 30 to the production control system 10 to the effect that processing will be started, thereby instructing execution of item name change (step 105 of FIG. 10).

On receipt of this command, the reference wafer item name management unit 12 of the production control system 10 changes the item name of the reference wafer, the processing of which has been finished, to an item name corresponding to the processing condition (step 106 of FIG. 10).

On completion of the processing in the wafer process device 30, the wafer process device 30 notifies the production control system 10 of the combination of the product lot ID and the reference wafer lot ID processed in the same batch set (\mathring{1}of FIG. 9, step 107 of FIG. 10). Responsive to this command, the lot data management unit 13 of the production control system 10 supervises the correspondence between the product lot and the reference wafer lot (step 108 of FIG. 10).

The product lot and the reference wafer are recovered (\mathring{5} of FIG. 8, step 109 of FIG. 10).

The product lot is transported to the next step (\mathring{6}of FIG. 8).

The reference wafer is transported to the measurement device 40 for measurement (\mathring{7}of FIG. 8, step 110 of FIG. 10).

The measurement data are transmitted to the production control system 10 (\mathring{2}of FIG. 10). The lot data management unit of the production control system 10 appends the measurement data to data of the product wafers in the database 11 (\mathring{3}of FIG. 9, step 111 of FIG. 10).

In the standard value management unit 14 of the production control system 10, the measurement data are compared to the standard values (step 112). In case of NG, the progress of the process for products processed simultaneously is halted (\mathring{4}of FIG. 9, step 113 of FIG. 10).

Referring to FIG. 9, in an embodiment of the present invention, the production control system 10 in the database 11 registers and supervises the relation of correspondence between the lot ID of the reference wafer ([A] of the NPW lot) of the reference wafer and the product lot ID (extension lot [B]) (see record data 111 of FIG. 9).

Also, the production control system 10 in the database 11 supervises the upper and lower limits of the measured data of the reference wafer on the condition basis by the measurement device 40 (record data 112 of FIG. 9). The production control system 10 also receives measured data from the measurement device 40 to store measured data of the reference wafer by the measurement device 40 in a data area corresponding to the gate oxidation process, which is the developing process, as data of the product wafer (it is noted that the product lot ID of the product wafer is the extended lot B). Reference is had to a record data 113 of FIG. 9.

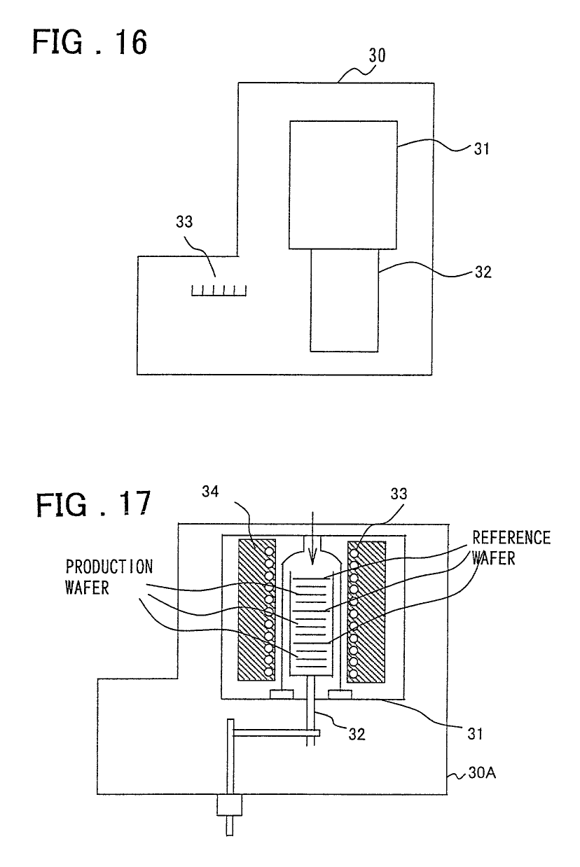

A second embodiment of the present invention is now explained. FIG. 16 illustrates a wafer process device embodying the present invention. The wafer process device 30 includes a reference carrier 35 having a reference wafer lot stored therein and a mechanism for holding the reference wafers in the wafer process device 30 and for sorting and loading the reference wafers therein at the time of loading the product wafers on the chamber 31. The present second embodiment of the present invention is directed to a wafer process device of the above-described structure.

The plural reference wafers, charged as samples into a production line for semiconductor devices, are afforded at the outset with a common representative name in the production control system, and the plural reference wafers are collectively housed on a storage shelf without being classified according to the processing conditions on the wafer process device, as in the embodiment described above. In the second embodiment of the present invention, the item names of the reference wafers at the start time of the processing on the wafer process device 30 are changed, as in the embodiment described above.

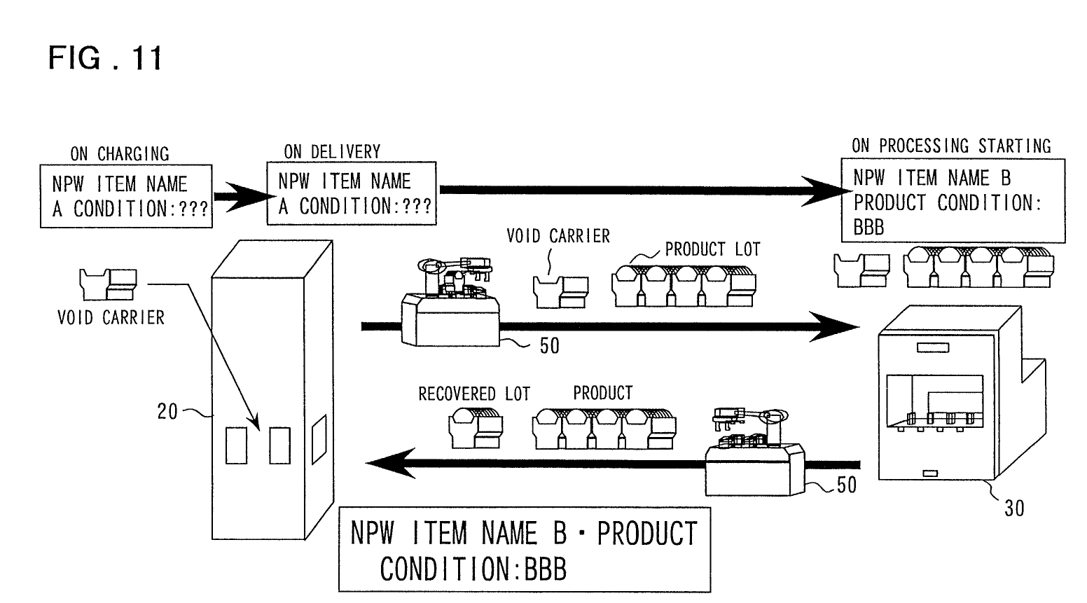

FIG. 11 schematically shows an embodying the present invention of changing the item name in the second embodiment of the present invention. Referring to FIG. 11, the item name of the reference wafer is set to A at the time of introducing. If the condition in the wafer process device 30 is BBB, the item name is changed on startup of the processing to a name reflecting the same condition BBB as that of the product wafer, with the product name being B. The item name of the reference wafer lot recovered by the carrier (recovery lot of FIG. 11) is B, which reflects the condition BBB of the product wafer. Meanwhile, if the product lot is routed from the storage shelf 20 to the wafer process device 30, vacant carriers are transported for reference wafer lot recovery, as will be explained subsequently.

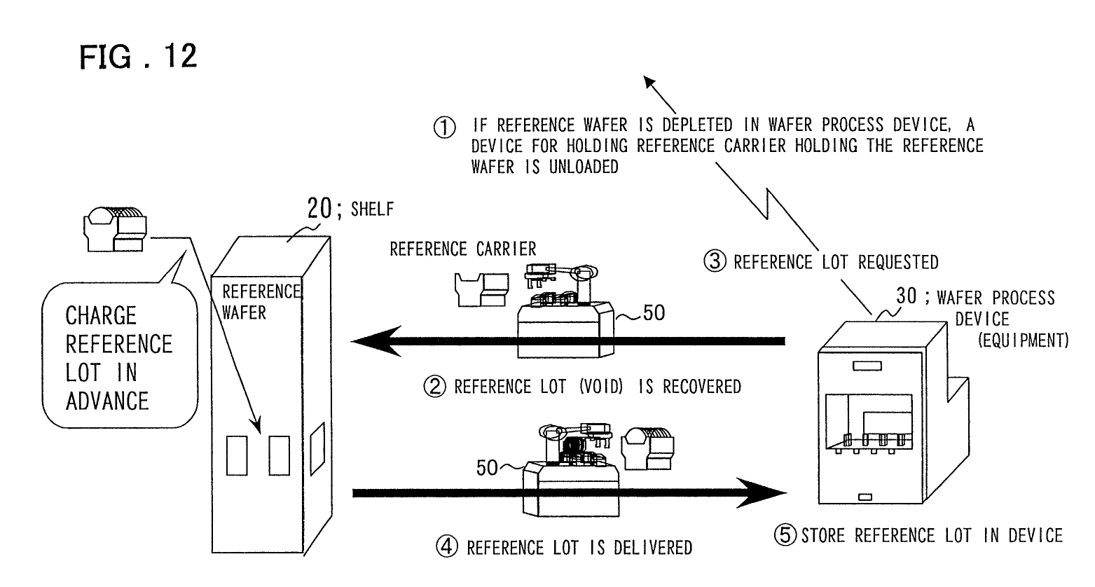

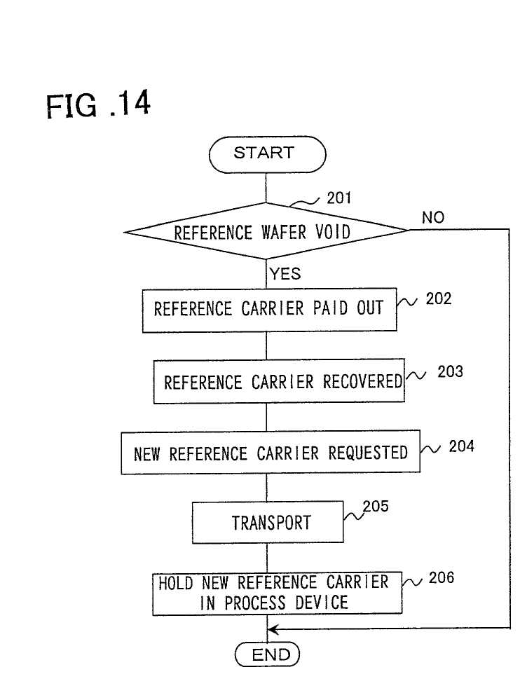

FIG. 12 shows the supply process for reference wafers in the second embodiment of the present invention. FIG. 14 illustrates the reference wafer furnishing process in the second embodiment of the present invention by a flow diagram. Referring to FIGS. 12 and 14, the reference wafer furnishing process in the second embodiment of the present invention is explained in detail.

If, in the wafer process device 30, the reference wafers are depleted, the vacant reference carrier is taken from the wafer process device 3 (\mathring{1}of FIG. 12, steps 201 and 202 of FIG. 14).

The reference carrier is recovered (\mathring{2}of FIG. 12, step 203 of FIG. 14).

The wafer process device 30 requests a new reference carrier from the shelf management system 21 (\mathring{3}of FIG. 12, step 204 of FIG. 14).

A preset number (corresponding to one lot, such as 25) of reference wafers are taken from the storage shelf 20 and accommodated in the reference carrier so as to be transported to the wafer process device 30 (\mathring{4}of FIG. 12, step 205 of FIG. 14).

The transported reference wafer lot is accommodated in the wafer process device 30 (\mathring{5}of FIG. 12, step 206 of FIG. 14).

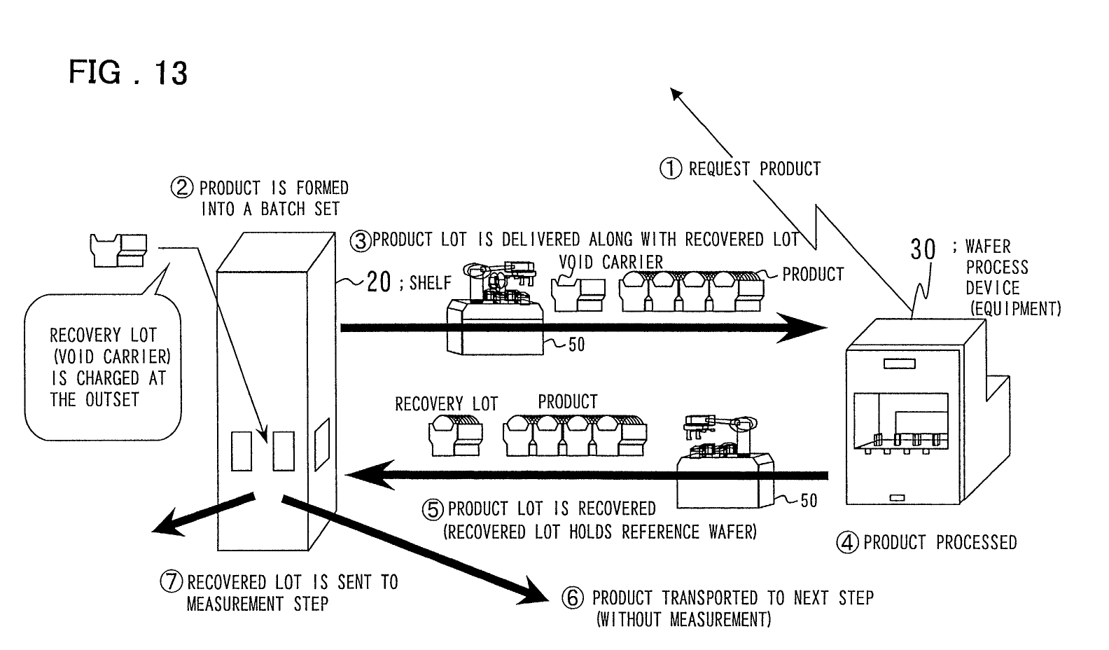

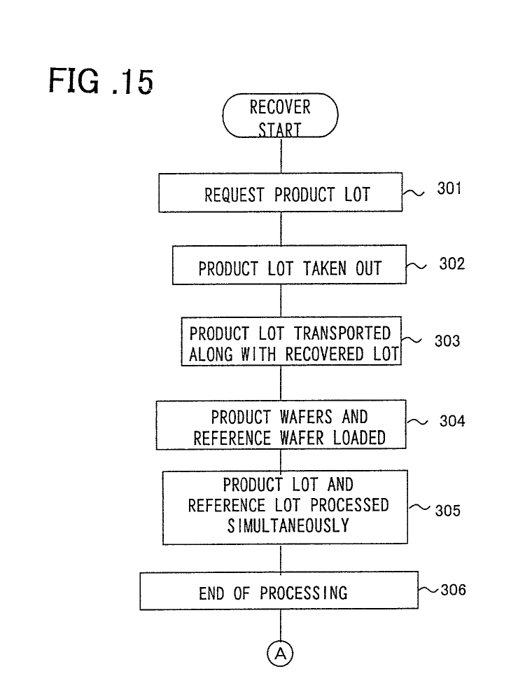

FIG. 13 illustrates the recovery process of the reference wafers in the second embodiment of the present invention. FIG. 15 shows, in a flow diagram, the reference wafer recovery process in the second embodiment of the present invention. Referring to FIGS. 13 and 15, the reference wafer recovery process in the second embodiment of the present invention is now explained.

A request for product lot is notified to the shelf from the wafer process device 30 (\mathring{3}of FIG. 13, step 301 of FIG. 15).

The product wafers processed under the same condition in the wafer process device 30 are automatically sorted and accommodated in a carrier on the lot basis to form a batch (\mathring{2} of FIG. 13, step 303 of FIG. 15).

The product wafers processed under the same condition by the wafer process device 30 are sorted automatically and accommodated lot-by-lot in a carrier to form a batch (\mathring{3}of FIG. 13, step 303 of FIG. 15).

In the wafer process device 30, the batch set and the reference wafers in the wafer process device 30 are sorted and loaded in a chamber for processing (\mathring{4}of FIG. 13, steps 304, 305 of FIG. 15). At this time, the wafer process device 30 commands execution of automatic change of the reference wafer item name in the database 11 of the production control system 10 to an item name associated with the processing condition, as in the embodiment described above. The processing as from this time is the same as the processing as from step 108 of FIG. 10.

Referring to FIG. 13, the product and the recovery carrier accommodating the reference wafer are recovered from the wafer process device 30 (\mathring{5}). The product lot is transported to the next step (\mathring{6}). The reference wafer accommodated in the recovery carrier is transported to the measurement device 40 for measurement (\mathring{7}). The extension of measured data in the measurement device 40 into data of the product wafers and the processing in the case of the unusual measurement data are the same as those in the previous embodiment.

In the above-described embodiment, management of the reference values and comparison of the measured data of the reference wafer to the reference value in the measurement device 40 are monistically supervised in the production control system 10. Alternatively, it is also possible to carry out comparison of the measured data of the reference wafer to the reference value in the measurement device 40 on the side measurement device 40 and to notify the result of comparison to the production control system 10 in a distributed processing configuration. Moreover, although the shelf management system 21 is provided outside of the shelf management system 20 for better visibility, it is of course possible to provide the shelf management system 21 in the shelf management system 20.

The meritorious effects of the present invention are summarized as follows.

As described above, the following meritorious effect can be derived in accordance with the present invention.

The first meritorious effect is that the shelf space for accommodating the reference wafers can be utilized efficiently.

The reason is that, in the present invention, the plural reference wafers can be stored on the shelf collectively without classifying the wafers according to processing conditions to render it possible to reduce the number of reference wafers stored on the shelf.

The second meritorious effect is that, if the result of measurement of the reference wafers is NG, the progress of the process of the product wafers, processed simultaneously with the reference wafers, can be stopped instantly.

The reason is that, in the present invention, the relation of correspondence between the reference wafers and the product lot is supervised in the production control system and, on detection of unusual or defective results of measurement of the reference wafers, a command necessary for stopping the processing of the product lot is sent out instantly to each device of the production line.

The third meritorious effect is that the product wafers and the reference wafers can be managed reliably.

The reason is that, in the present invention, lot management of the product lot and the reference wafers is carried out at the time point of end of processing of the wafer process device.

The fourth meritorious effect is that product reject analyses may be facilitated.

The reason is that, in the present invention, measured data of the reference wafers are managed as data of the product wafers.

It is specifically noted that the present invention has been described based on the wafers as a product. However, the present invention is equally applicable to any product and a reference product for checking the quality of the product in a lot.

Thus the present invention may be generalized to the reference products or products in general, in which the term “wafer” should be replaced by “reference product” or simply “product”, and the “wafer process device” is replaced by the “production process device” in general.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A method for supervising a reference wafer introduced as specimen into a production line for semiconductor devices, comprising:
(a) providing a system for supervising said production line with a function of changing the item name of said reference wafer;
(b) according, in said system, a preset common representative name to plural reference wafers introduced for maintenance or evaluation of a wafer process device; and
(c) accommodating, upon warehousing said plural reference wafers to a storage shelf, said reference wafers in said storage shelf collectively without classification according to processing conditions in said wafer process device in which said reference wafers are to be processed.

2. A method for supervising reference wafers introduced as specimens into a production line for semiconductor devices, comprising the steps of:
(a) according a preset common representative name as an item name to plural reference wafers introduced into a wafer process device, memorizing and supervising the representative name;
(b) holding said representative name of said reference wafer as from the time of warehousing said reference wafer on said storage shelf until delivery thereof from said storage shelf and confirmation of actual processing to be performed in said wafer process device; and
(c) changing the item name of said reference wafer from said representative name to an item name adapted for conditions of said actual processing if it is confirmed that the processing is to be made in said wafer process device.

3. The method for supervising reference wafers as defined in claim 2 wherein, upon starting the processing in said wafer process device, the item name of said reference wafer is changed from said representative name to an item name adapted for said processing conditions.

4. A method for supervising reference wafers introduced as specimens into a production line for semiconductor devices, wherein
a product ion control system responsible for management of the production line accords a common representative name as an item name to introduced reference wafers and warehouses the reference wafers, afforded with said common representative name, in a storage shelf collectively without classification according to processing conditions in said wafer process device in which said reference wafers are to be processed; and wherein
said production control system holds said representative name accorded to said reference wafers until said reference wafers are delivered for processing by said wafer process device, transported and processed by said wafer process device.

5. The method for supervising reference wafers as defined in claim 4 wherein
at a time point when said reference wafer is processed by said wafer process device along with product wafers, an item name of said reference wafers is changed from said representative name to an item name representing said processing condition.

6. The method for supervising reference wafers as defined in claim 4 wherein, at the time of delivery of said reference wafers from said storage shelf, a command for changing the item name to an item name corresponding to conditions of processing performed in said wafer process device on said reference wafers is sent from said storage shelf side to said production control system side; and wherein
at a time point when said reference wafers are transported from said storage shelf to a destination wafer process device and loaded in a processing chamber in said wafer process device to start the processing, said production control system changes, in response to a notice from said wafer process device for start of processing, the item name of said reference wafers from said representative name to an item name corresponding to conditions of processing performed in said wafer process device on said reference wafers.

7. The method for supervising reference wafers as defined in claim 4 wherein
when the processing in said wafer process device is finished, a lot identification information, termed as “ID” hereinafter, of said product wafers and a lot ID of said reference wafers processed as the same set in said wafer process device are notified to said production control system, and wherein
in said production control system, the relation of correspondence between the lot ID of said product wafers and the lot ID of said reference wafers is registered and supervised.

8. The method for supervising reference wafers as defined in claim 4 wherein
if, in a wafer process device adapted for accommodating a preset number of reference wafers in a main body portion of said wafer process device, a reference wafer set is empty, a reference wafer is delivered from said storage shelf and accommodated in said wafer process device for storage therein;
if, in said wafer process device, the product lot transported from said storage shelf and said reference wafers in said wafer process device are loaded in a processing chamber to start the processing, starting of the processing is notified to said production control system; and wherein
said production control system changes, in response to a notice for start of processing from said wafer process device, an item name of said reference wafers from said representative name to an item name corresponding to conditions of processing performed in said wafer process device on said reference wafers.

9. The method for supervising reference wafers as defined in any one of claims 4 to 8 wherein
in said wafer process device, after the end of processing of a set of a lot of said product wafers and a lot of the reference wafer, said set of the lot of said product wafers and the reference wafer lot is transported and recovered from said wafer process device, measurement is performed on said reference wafers in a measurement device; and wherein
in said production control system, said measured results are appended in said production control system to data pertinent to the process in said wafer process device for said product wafers.

10. A method for supervising a reference wafer comprising:
(a) a step of selecting reference wafers, in a storage shelf storing reference wafers to which a common representative name pre-defined on a production control system side supervising the production line for semiconductor devices has been afforded to provide a lot of reference wafers, and selecting product wafers which are processed under the same conditions in a wafer process device to provide a lot of product wafers, said reference wafer lot and said product wafer lot being accommodated in a carrier and grouped together as one set;
(b) a step of issuing, upon delivering the lot of said product wafers and the reference wafer lot from said storage shelf, a command to said production control system, said command setting an item name of the delivered reference wafers to a condition for processing in said wafer process device;
(c) a step of transporting a set of said product wafer lot and said reference wafer lot from said storage shelf to said wafer process device;
(d) a step of commanding, upon loading said product wafer lot and said reference wafer lot in a chamber of said wafer process device to start the processing, to change the item name of said reference wafers from said production control system to said wafer process device;
(e) a step of changing, in said production control system, the item name of said reference wafer from the representative name to an item name conforming to the conditions in said wafer process device, under the command for changing the item name;
(f) a step of notifying, at the time of finishing the processing in said wafer process device, the relation of correspondence between said product wafer lot and said reference wafer lot, processed simultaneously, to said production control system;
(g) a step of registering and managing, responsive to the notice from wafer process device, the relation of correspondence between said product lot and the reference wafer lot;
(h) a step of recovering the processed product wafer lot and reference wafer lot from said wafer process device;
(i) a step of transporting the recovered product wafer lot to a next step;
(j) a step of transporting the recovered reference wafer lot to a measurement device and Performing measurement; and
(k) a step of warehousing the measured reference wafer lot from said measurement device to said storage shelf.

11. A method for supervising reference wafers introduced as specimens into a production line for semiconductor devices, comprising:
(a) a step of according, in a production control system responsible for management of a production line, a preset common representative name to plural reference wafers introduced into a wafer process device;
(b) a step of collectively accommodating said plural reference wafers in a storage shelf without classification in accordance with the conditions for processing in a wafer process device where said reference wafers are to be processed;
(c) a step of disintroducing a empty reference carrier from a storage shelf, if, in a wafer process device adapted for accommodating a preset number of reference wafers along with product wafers as a set of the both wafers in a main body portion thereof, a lot of the reference wafers is empty;
(d) a step of automatically transporting said reference carrier to said storage shelf; and
(e) a step of delivering the reference carrier accommodating the reference wafers therein from said storage shelf and transporting the reference carrier to said wafer process device for accommodating the reference wafers in said wafers process device.

12. A method for supervising reference wafers, comprising:
(a) a step of according, in a production control system responsible for management of said production line, a preset common representative name to plural reference wafers introduced as specimens into a production line for semiconductor devices;
(b) a step of collectively accommodating said plural reference wafers, without classification in accordance with conditions of processing in a wafer process device where the reference wafers are to be processed;
(c) a step of notifying a request for a product lot to said storage shelf from a wafer process device provided with a reference carrier for accommodating a preset number of reference wafers in a main body portion of the device, said wafer process device being adapted for simultaneously processing the reference wafers along with the product lot;
(d) a step of automatically sorting the product wafers processed under the same condition in said wafer process device and accommodating the sorted product wafers on the lot basis in a carrier to form a set;
(e) a step of transporting to said wafer process device a carrier of the set of the product lot, and a empty carrier for recovery of reference wafers from said storage shelf to said wafer process device;
(f) a step of commanding, upon loading, in said wafer process device, said product lot and the reference wafers in said wafer process device in a chamber for processing, change of item name of said reference wafers from said wafer process device to said production control system;
(g) a step of changing, in said production control system, the item name of said reference wafers from a representative name to an item name conforming to the condition in said wafer process device, responsive to said command for changing the item name;
(h) a step of notifying, at the end of processing in said wafer process device, the relation of correspondence between the product lot and the reference wafer lot, processed simultaneously, to said production control system;
(i) a step of registering and managing, in said production control system, the relation of correspondence between the product lot and the reference wafer lot, responsive to said notice from said wafer process device;
(i) a step of recovering the product lot and the carrier accommodating said reference carriers from said wafer process device;
(k) a step of transporting the recovered product lot to a next step;
(l) a step of transporting the recovered reference wafers to a measurement device for performing measurement; and
(m) a step of warehousing the measured reference wafers from said measurement device to said storage shelf.

13. The method for supervising reference wafers as defined in claim 10 wherein
negative and positive results of measurement in said measurement device of said reference wafers are automatically verified and, if the results of check are negative, control is managed not to introduce the product lot processed in said wafer process device in the same set as said reference wafer into the next step, while control is also managed to halt the processing in said next step.

14. The method for supervising reference wafers as defined in claim 10 wherein
negative and positive results of measurement in said measurement device of said reference wafers are automatically verified and, if the results of check are negative, an alarm is issued, the product lot processed in the same set as said reference wafer is identified and an operator is advised of necessary measures.

15. A storage shelf for storing a reference wafer or both a reference wafer and a product wafer as a lot, wherein
upon introducing plural reference wafers into a line, plural reference wafers, afforded with a preset representative name in a production control system, are accommodated collectively as a lot without classification in accordance with processing conditions in a wafer process device where said reference wafers are to be processed.

16. A production control system for supervising wafers introduced into a line, comprising:
means for affording said reference wafers with a preset representative name, upon introducing the reference wafers, and
means for changing, at a time point of processing said reference wafers in a wafer process device, an item name of said reference wafers from said representative name to an item name conforming to the processing conditions.

17. A reference wafer supervising system comprising:
(a) a shelf management system having a storage shelf for storing wafers to be introduced into a production line and adapted for automatic warehousing and delivery of said wafers;
(b) a wafer process device;
(c) a control system controlling automatic transporting of the wafers;
(d) a production control system for supervising the production line of semiconductor devices; and
(e) a measurement device for measuring reference wafers as specimens;
wherein
(f) said production control system affords a preset common representative name to plural reference wafers and introduces the wafers into a line;
(g) said storage shelf being designed to collectively accommodate said reference wafers without classification in accordance with conditions under which said reference wafers are to be processed; and
(h) the system also comprises means for changing an item number of said reference wafers delivered from said storage shelf for processing in said wafer process device, at a time point when the processing is finished, to an item name conforming to a condition under which said reference wafers are processed in said wafer process device.

18. The reference wafer supervising system as defined in claim 17 wherein
at a time point of starting the processing in said wafer process device, the item name of said reference wafer is changed from said representative name to an item name conforming to said processing conditions.

19. The reference wafer supervising system as defined in claim 17 wherein
the system sends, upon delivering said reference wafers from said storage shelf, a signal for changing an item name of said reference wafers to an item name corresponding to a condition to which said reference wafers are subjected in said wafer process device;
said wafer process device sends a processing start signal to said production control system at a time point when said reference wafers are transported from said storage shelf to a destination wafer process device and loaded thereon, and processing on the reference wafer is started; and wherein
there is provided means for changing the item name of the reference wafer stored in a database of said production control system to an item name conforming to said processing condition if the signal for commanding change in the item name from the shelf management system is already received in said product ion control system and a processing start signal is received from the wafer process device.

20. The reference wafer supervising system as defined in claim 17 wherein
if the processing is finished in said wafer process device, a lot ID of the product wafers and a lot ID of said reference wafers processed simultaneously in said wafer process device are notified to said production control system, and wherein
the relation of correspondence between the lot ID of the product wafers and the lot ID of said reference wafers is registered and supervised in said production control system.

21. The reference wafer supervising system as defined in claim 17 wherein
after the end of processing in said wafer process device, said reference wafers are measured in said measurement device, the measured results in said measurement device are received by said production control system, and
said production control system includes means for appending data of said product wafer to processed data in said wafer process device.

22. The reference wafer supervising system as defined in claim 17 further comprising:
control means for automatically verifying whether the measured results in said reference wafer measurement device are positive or negative and for managing control for stopping transfer to and processing in the next step of the product lot processed by said wafer process device in the same set as said reference wafers if the verified results are negative.

23. The reference wafer supervising system as defined in claim 17 further comprising:
control means for automatically verifying whether the measured results in said reference wafer measurement device are positive or negative and for issuing an alarm if the verified results are negative, said control means specifying a product lot processed by said wafer process device in the same set as said reference wafers for advising an operator of necessary measures.

24. A reference wafer management system comprising:
(a) a shelf management system carrying out automatic warehousing/delivery of wafers to be introduced into a production line, said shelf management system having a storage shelf for storing said wafers,
(b) a wafer process device,
(c) a production control system supervising a production line of semiconductor devices, and
(d) a measurement device measuring a reference wafer as a specimen;
(c) said production control system comprising:
(c1) reference wafer item name management means for supervising a pre-change item name and a post-change item name of said reference wafer;
(c2) lot data management means for managing correspondence between a product wafer lot processed by a wafer process device and a reference wafer lot and for managing data;
(c3) standard value management means for supervising condition-based standard values pertinent to processing in said wafer process device;
(c4) said production control system being connected to a database for memorizing and supervising a process sequence and wafer data,
(c5) said production control system according a preset common representative name to a plurality of said reference wafers at the time of introducing the reference wafers into a line, and storing said plural reference wafers collectively in said storage shelf without classification in accordance with conditions under which said reference wafers are to be processed;
(c1) said reference wafer item name management means comprising:
(c1a) means for supervising an item name change command of the reference wafers from said wafer process device and
(c1b) means for recognizing a notification for starting the processing as an item name change execution command on receipt of said notification from said wafer process device at a time point of processing of said reference wafers and said product wafers on said wafer process device, and for changing the item name of said reference wafers in said database from said representative name into an item name which reflects the processing condition of said wafer process device;
(c2) said lot data management means comprising:
(c2a) means for receiving a notification of a lot ID of product wafers and a lot ID of said reference wafers, processed simultaneously, from said wafer process device, at the time of end of processing in said wafer process device, and for registering and supervising on said database the correspondence between the lot ID of the product wafers and the lot ID of the reference wafers processed simultaneously on said wafer process device, and
(c2b) means for expanding (setting) the measured data by said measurement device of the reference wafer processed by said wafer process device onto data of the product wafer on said database;
(c3′) said standard value management means comprising:
(c3a) means for comparing measured data by said measurement device of said reference wafer processed by said wafer process device, and
(c3b) means for managing control to stop the processing of the product lot processed simultaneously as the reference wafers if the result of comparison is negative.

25. The reference wafer management system as defined in claim 22 wherein said reference wafer item name management means (c1) further comprising:
(c1c) change command management means for receiving and supervising a command for changing an item name of the reference wafers and a command for executing the changing of the item name from said shelf management system and said wafer process device;
(c1d) item name associating means for associating the pre-change item name and the post-change item name of said reference wafers in said database; and
(c1e) item name changing means for changing the item name of said reference wafers in said database.

26. The reference wafer management system as defined in claim 22 wherein said lot data management means (c2) further comprises:
(c2c) lot management means for supervising the correspondence between the product lot ID and the reference wafer lot ID, processed simultaneously on said wafer process device as a set, responsive to an end signal from said wafer process device at the time of end of processing in said wafer process device, and
(c2d) data expanding means for setting the measured data of the processed reference wafer by said measurement device on product wafer data.

27. The reference wafer management system as defined in claim 22 wherein said standard value management means (c3) comprises:
(c3a) data management means for performing setting management to said database of condition-based standard values in said wafer process device;
(c3b) data comparator means for comparing measured data in said measurement device of said processed reference wafers to standard values; and
(c3c) unusual state detection means for managing control for halting processing of a product lot processed simultaneously as said reference wafers and said reference wafers, and for issuing an alarm or command as necessary if, as a result of comparison in said data comparator means, said measured data exceeds or is less than the standard value.

28. In a system comprising:
a shelf management system having a storage shelf on which to store wafers introduced into a production line and adapted for automatically warehousing and delivering said wafers,
a wafer process device of a batch type,
a production control system supervising the production line for semiconductor devices, and
a measurement device for measuring reference wafers as specimens; in which
in said production control system at the time of introducing the reference wafers into a line, a preset common representative name is afforded to plural reference wafers, said reference wafers being collectively stored in said storage shelf without being classified in accordance with processing conditions in said wafer process device;
wherein said production control system comprises a database for storing process management data and wafer data;
a program product for execution by a computer making up said production control system comprising the steps of:
(a) processing of affording a preset common representative name to said plural reference wafers in introducing reference wafers to a line, and changing, on receipt of a notification of processing starting from said wafers process device at a time point when said reference wafers and the product wafers are processed on said wafers process device, the item name of said reference wafers on said database from a representative name to an item name conforming to a processing condition on said wafer process device;
(b) processing of registering and supervising, on receipt of the notification of a product wafer lot ID and a reference wafer lot ID processed simultaneously on said wafer process device at the time of processing end of said wafer process device, the correspondence between the product wafer lot ID and the reference wafer lot ID processed simultaneously on said wafer process device;
(c) processing of expanding measured data by said measurement device of the reference wafers processed by said wafer process device onto data of the product wafers on said database;
(d) processing of comparing measured data by said measurement device of the reference wafer processed by said wafer process device to standard values on said database; and
(e) processing of managing control to stop the processing of the product lot processed simultaneously as said reference wafer if the result of comparison is negative.

29. A medium carrying the program product as defined in claim 28.

30. A method for supervising a reference product introduced as specimen into a production line for semiconductor devices, comprising:
(a) providing a system for supervising said production line with a function of changing the item name of said reference product;
(b) according, in said system, a preset common representative name to plural reference products introduced for maintenance or evaluation of a production process device; and
(c) accommodating, upon warehousing said plural reference products to a storage shelf, said reference products in said storage shelf collectively without classification according to processing conditions in said production process device in which said reference products are to be processed.

31. A method for supervising reference products introduced as specimens into a production line for semiconductor devices, comprising the steps of:
(a) according a preset common representative name as an item name to plural reference products introduced into a production process device, memorizing and supervising the representative name;
(b) holding said representative name of said reference product as from the time of warehousing said reference product on said storage shelf until delivery thereof from said storage shelf and confirmation of actual processing to be performed in said production device; and
(c) changing the item name of said reference product from said representative name to an item name adapted for conditions of said actual processing if it is confirmed that the processing is to be made in said production process device.

32. The method for supervising reference products as defined in claim 31 wherein, upon starting the processing in said production process device, the item name of said reference product is changed from said representative name to an item name adapted for said processing conditions.
